(19) United States
(12) Patent Application Publication
(10) Pub. No.: US 2026/0172958 A1
(43) Pub. Date: Jun. 18, 2026

(54) SYSTEMS, DEVICES, AND METHODS FOR ANALYZING WIRELESS COMMUNICATION DEVICE CAPABILITIES IN A WIRELESS NETWORK

(71) Applicant: Ekahau, Inc., New York, NY (US)

(72) Inventors: Olli Alanen, Helsinki (FI); Matthew Starling-McFadden, Bushey (GB); Janne Kurjenniemi, Jyväskylä (FI)

(73) Assignee: Ekahau, Inc., New York, NY (US)

(21) Appl. No.: 18/985,630

(22) Filed: Dec. 18, 2024

(51) Int. Cl. H04W 48/20; H04W 48/16

(52) U.S. Cl. CPC H04W 48/20; H04W 48/16

(57) ABSTRACT

The devices, systems, and methods described herein are directed to extracting information from wireless signals received from one or more wireless communication devices. The extracted information indicates a first set of capabilities associated with the wireless communication device that transmitted the wireless signals. The first set of capabilities is compared with a second set of capabilities associated with one or more other wireless communication devices. In some examples, information regarding the comparison of the first set of capabilities and the second set of capabilities is presented to a user.

### FIELD

The subject matter described herein relates to communication between devices in a wireless network and more particularly to analyzing the wireless communication capabilities of wireless communication devices in the wireless network.

### BACKGROUND

Wi-Fi is a family of wireless network protocols based on the Institute of Electrical and Electronics Engineers (IEEE) 802.11 family of standards, which are commonly used for local area networking of devices and Internet access, allowing nearby digital devices to exchange data via radio waves. Wi-Fi networks are some of the most widely used computer networks in the world, used globally in home and small office networks to link devices together and to connect them to the Internet via a wireless router. Wi-Fi networks often use wireless access points in public places like coffee shops, hotels, libraries, and airports to provide visitors with Internet connectivity for their mobile devices.

### SUMMARY

The devices, systems, and methods described herein are directed to extracting information from wireless signals received from one or more wireless communication devices. The extracted information indicates a first set of capabilities associated with the wireless communication device that transmitted the wireless signals. The first set of capabilities is compared with a second set of capabilities associated with one or more other wireless communication devices. In some examples, information regarding the comparison of the first set of capabilities and the second set of capabilities is presented to a user.

### BRIEF DESCRIPTION OF THE DRAWINGS

FIG. 1 is a block diagram of a first example of a system for performing a wireless communication capability analysis. The system includes a measurement device and a computing device to perform the analysis.

FIG. 2 is a block diagram of an example of the measurement device shown in FIG. 1.

FIG. 3 is a block diagram of a second example of a system for performing a wireless communication capability analysis in which the measurement device is integrated into the computing device.

FIG. 4A is a block diagram of an example of a system in which a measurement device is used to receive the wireless signals that are the basis for a wireless communication capability analysis.

FIG. 4B is a block diagram of an example of a system in which an access point is used to receive the wireless signals that are the basis for a wireless communication capability analysis.

FIG. 4C is a block diagram of an example of a system in which a client device is used to receive the wireless signals that are the basis for a wireless communication capability analysis.

FIG. 5 is a flow chart of a first example of a method for performing a wireless communication capability analysis.

FIG. 6 is a flow chart of a second example of a method for performing a wireless communication capability analysis.

### DETAILED DESCRIPTION

Since Wi-Fi (e.g., wireless) networks are very widely deployed in different environments, one of the most important use cases is the analysis of the wireless communication capabilities of the various wireless communication devices associated with the wireless network or that may attempt to associate with the wireless network. Currently, in order to analyze the capabilities of wireless communication devices in a wireless network, a professional Wi-Fi expert must capture packets transmitted by the client devices and access points (APs) of a wireless network and then utilize a packet capture dissector to inspect the capabilities of the client devices and APs. This inspection process is performed manually by the professional Wi-Fi expert to compare the capabilities of the wireless communication devices and to determine what might be causing connectivity problems or inefficiencies. This manual inspection process is very slow and difficult, even for world-class Wi-Fi experts. For a non-expert, such an inspection is an almost impossible task, yielding inconclusive and inaccurate results. The systems, devices, and methods described herein facilitate wireless communication capability analysis and optimization for both experts and non-experts alike.

For example, in the context of analyzing a Wi-Fi network, determining the capabilities of the wireless communication devices (e.g., access points and client devices) is the first step of the process. In some examples, the capabilities are indicated by client devices and access points in various scanning procedures and/or frames that are exchanged while establishing connectivity. Once the capabilities of the wireless communication devices are determined, comparisons between the respective capabilities of the wireless communication devices can provide meaningful insights and can be the basis for making recommendations on changes that can be made to improve connection quality for the wireless communication devices, as well as optimizing overall performance of the wireless network.

The devices, systems, and methods described herein are directed to extracting information from wireless signals received from one or more wireless communication devices. The extracted information indicates a first set of capabilities associated with the wireless communication device that transmitted the wireless signals. The first set of capabilities is compared with a second set of capabilities associated with one or more other wireless communication devices. In some examples, information regarding the comparison of the first set of capabilities and the second set of capabilities is presented to a user.

Although the different examples of devices, systems, and methods may be described herein separately, any of the features of any of the examples may be added to, omitted from, or combined with any other example. Similarly, any of the features of any of the examples may be performed in parallel or performed in a different manner/order than that described or shown herein.

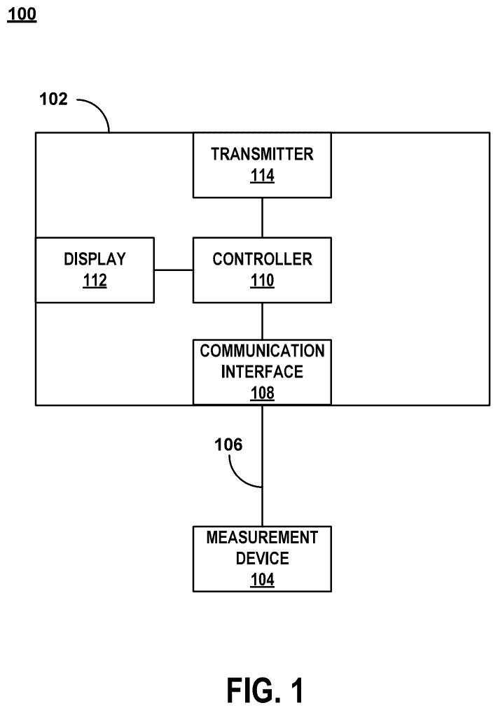

FIG. 1 is a block diagram of a first example of a system for performing a wireless communication capability analysis. In the example shown in FIG. 1, system 100 includes local computing device 102 and measurement device 104. In some examples, local computing device 102 can be any on-site computing device that can receive and process data associated with a wireless network. For example, local computing device 102 could be a tablet computer, a laptop computer, a smartphone, or a desktop computer. In other examples, any other suitable computing device, even a remote, off-site computing device, could be used to perform the functions described herein.

Local computing device 102 includes communication interface 108, controller 110, display 112, and transmitter 114. In operation, local computing device 102 receives data from measurement device 104 via communication link 106. Communication interface 108 enables communication between measurement device 104 and local computing device 102. In the example shown in FIG. 1, communication link 106 is a wired communication link that operates in accordance with at least one of the family of Universal Serial Bus (USB) specifications. In other examples, communication link 106 may operate in accordance with other wired specifications. In further examples, communication link 106 may operate in accordance with any suitable wireless specification (e.g., Bluetooth).

Controller 110 includes any combination of hardware, software, and/or firmware for executing the functions described herein. An example of a suitable controller 110 includes software code running on a microprocessor or processor arrangement connected to memory (not explicitly shown).

Display 112 is used to present information to a user regarding one or more wireless communication devices within a coverage area of a wireless network. As will be discussed more fully below, display 112 can be used to present a variety of information to the user. In the example shown in FIG. 1, display 112 includes an associated input mechanism (e.g., touchscreen) by which the user can select one or more wireless communication devices for wireless communication capability analysis. In some examples, the user can use the input mechanism to select one or more recommended actions to improve connectivity and/or network performance, given the capabilities of the various wireless communication devices within the wireless network. In further examples, any other suitable input mechanism may be used (e.g., keyboard, touchpad, mouse, microphone, etc.).

In the example shown in FIG. 1, transmitter 114 includes electronics configured to transmit wireless signals to one or more client devices within a coverage area of a wireless network. In some examples, transmitter 114 may include multiple transmitters. In other examples, transmitter 114 may be integrated into measurement device 104 or into a wireless communication device that is part of the wireless network or that is within the coverage area of the wireless network.

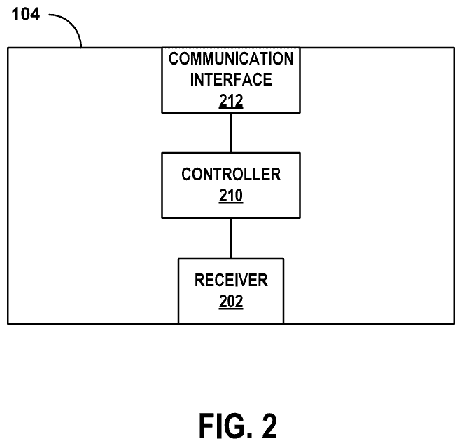

FIG. 2 is a block diagram of an example of measurement device 104 shown in FIG. 1. In the example shown in FIG. 2, measurement device 104 includes receiver 202 to receive Wi-Fi signals from various nodes of a Wi-Fi (e.g., wireless) network. In other examples, any other suitable number of receivers may be utilized in measurement device 104. Regardless of the number of receivers in measurement device 104, each receiver is capable of scanning and monitoring a set of Wi-Fi channels and capturing all Wi-Fi link layer frames (e.g., packets) being heard on those channels, in some examples. In other examples, a single Wi-Fi radio (e.g., receiver), module, or chipset can be configured to operate on the separate channels at the same time, which is referred to as a Dual Band Simultaneous (DBS) configuration. Thus, the functionality of the measurement device, as described herein, may be accomplished with a measurement device having multiple receivers or a single, properly configured receiver.

The measurement device 104 shown in FIG. 2 also includes controller 210, which processes the signals received by receiver 202. Controller 210 includes any combination of hardware, software, and/or firmware for executing the functions described herein. An example of a suitable controller 210 includes software code running on a microprocessor or processor arrangement connected to memory (not explicitly shown). It is worth noting that, in some examples, any of the functions described herein as being performed by controller 110 may be performed by controller 210, and vice versa.

Measurement device 104, as shown in FIG. 2, also includes communication interface 212, which measurement device 104 uses to communicate with local computing device 102 via communication link 106. In some examples, the communication between measurement device 104 and local computing device 102 includes providing data to local computing device 102 and receiving command instructions regarding which node or nodes of a wireless network are selected for wireless communication capability analysis.

In further examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive Wi-Fi signals, in other examples.

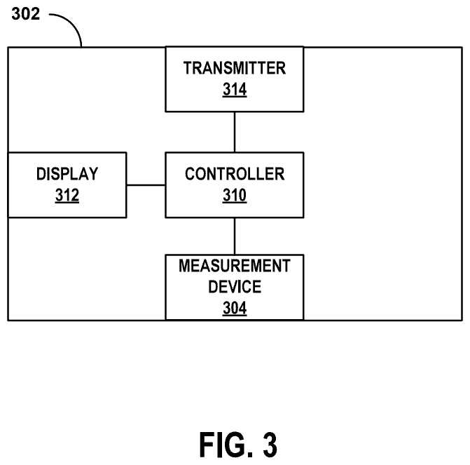

FIG. 3 is a block diagram of a second example of a system for performing a wireless communication capability analysis in which the measurement device is integrated into the computing device. In the example shown in FIG. 3, system 302 includes measurement device 304, controller 310, display 312, and transmitter 314. In the example shown in FIG. 3, controller 310 is capable of performing the combined functions of controller 110 and controller 210, as described in connection with FIGS. 1 and 2. Thus, system 302 performs the combined functions of measurement device 104 and local computing device 102, as described herein.

In operation, one or more receivers are used to receive wireless signals from one or more wireless communication devices located within a coverage area of a wireless network. As used herein, a “wireless communication device” is any device that is capable of wireless communication with other wireless communication devices. Examples of a wireless communication device include, for example, access points associated with a wireless network or client devices that are either associated with the wireless network or that are within a coverage area of the wireless network. In the following description, a “wireless communication device” may also be referred to as a node of a wireless network.

As used herein, a “node of a wireless network” can be used to describe any device that is capable of sending or receiving data to and from other nodes of the wireless network. In some examples, a “node” may be an end device, also referred to herein as a client device, that serves as a source point or a destination point in the communication that occurs on the wireless network. Examples of an end device include a laptop or desktop computer, a work station, a tablet, a mobile phone, a printer, a scanner, or a server, etc. In other examples, a “node” may be an intermediary device that is designed to forward data between other devices in the wireless network. Examples of an intermediary device include wireless access points, routers, or repeaters, etc.

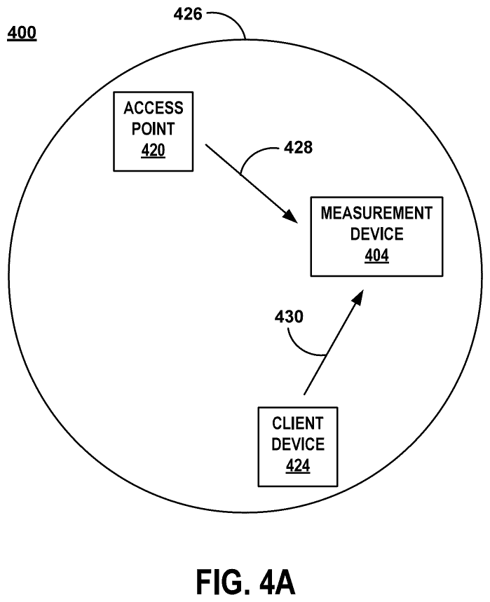

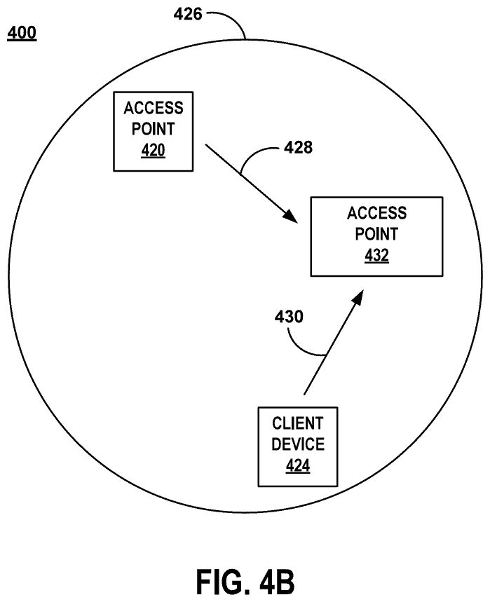

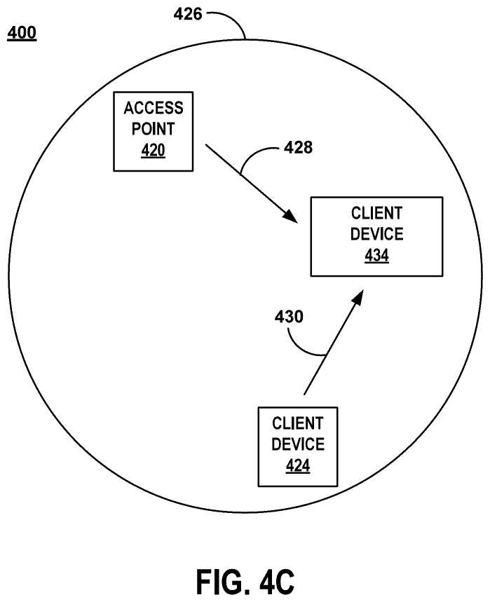

In the example shown in FIG. 4A, a block diagram of an example of a system is shown in which a measurement device is used to receive the wireless signals that are the basis for a wireless communication capability analysis. As shown in FIG. 4A, system 400 includes measurement device 404, access point 420, and client device 424. In other examples, any other suitable number of measurement devices, access points, and/or client devices may be part of the wireless communication capability analysis. In the example shown in FIG. 4A, measurement device 404 is communicatively coupled to a computing device (not explicitly shown in FIG. 4A). In other examples, measurement device 404 may be integrated into a local computing device.

Measurement device 404 has a structure and functionality similar to measurement device 104. Thus, measurement device 404 has a receiver to receive one or more wireless signals 428 from access point 420, which is associated with a wireless network having coverage area 426. The receiver of measurement device 404 also receives one or more wireless signals 430 from client device 424, which is located within coverage area 426 of the wireless network.

In some examples, the receiver of measurement device 404 receives the one or more wireless signals during a scanning procedure. For example, client device 424 may perform passive scanning procedures and/or active scanning procedures, in some examples. Passive scanning involves client device 424 listening for beacons sent from access points and building a list of available wireless networks based on the received beacons. In some examples, the beacon includes the wireless communication capabilities of the access point that transmitted the beacon. Thus, when measurement device 404 receives wireless signals 428 that contain a beacon, measurement device 404 is able to determine the wireless communication capabilities of access point 420.

Conversely, active scanning involves client device 424 sending a probe request that either specifies a service set identifier (SSID) or leaves the SSID field empty. In response to receiving a probe request specifying an SSID with which access point 420 is associated or a probe request with an empty SSID field, access point 420 will send a probe response that includes the wireless communication capabilities of access point 420. Thus, when measurement device 404 receives wireless signals 428 that contain a probe response, measurement device 404 is able to determine the wireless communication capabilities of access point 420.

In other examples, the receiver of measurement device 404 receives one or more wireless signals 430 from client device 424 during an association frame exchange. For example, client device 424 may transmit an association request frame, which is part of an association frame exchange, to access point 420. The association request frame includes the wireless communication capabilities of client device 424, in some examples. Thus, when measurement device 404 receives wireless signals 430 that contain the association request frame, measurement device 404 is able to determine the wireless communication capabilities of client device 424. In some examples, measurement device 404 uses its transmitter to transmit, to client device 424, one or more disassociation frames to cause client device 424 to re-associate with access point 420. In this manner, client device 424 can be triggered to transmit an association request frame, by which measurement device 404 can obtain the capabilities of client device 424.

In some examples, measurement device 404 has a controller that is used to extract, from wireless signals 428, first information that indicates a first set of capabilities associated with access point 420. The controller of measurement device 404 also extracts, from wireless signals 430, second information that indicates a second set of capabilities associated with client device 424. The controller of measurement device 404 generates a comparison of the first set of capabilities and the second set of capabilities.

As specified in the Institute of Electrical and Electronics Engineers (IEEE) 802.11 specification, wireless communication capabilities may be described in a hierarchical format. Thus, in some examples, the comparison of the first set of capabilities and the second set of capabilities comprises a hierarchical tree structure indicating one or more differences between the first set of capabilities and the second set of capabilities. In some of these examples, the similarities and differences between the first set of capabilities and the second set of capabilities are indicated by different color coding of the hierarchical tree structure. For example, similarities between the first set of capabilities and the second set of capabilities can be indicated by a first color (e.g., green) that indicates that there is a match for a particular capability when comparing the first set of capabilities and the second set of capabilities. Non-matching values between the first set of capabilities and the second set of capabilities can be indicated by a second color (e.g., yellow) that indicates that there are different values for a particular capability when comparing the first set of capabilities and the second set of capabilities. A non-existent value in the first set of capabilities and/or the second set of capabilities can be indicated by a third color (e.g., red) that indicates that the value is non-existent for a particular capability when comparing the first set of capabilities and the second set of capabilities. In this regard, a non-existent value may indicate the absence of a value for that particular capability or the presence of a null value for that particular capability.

In other examples, the comparison of the first set of capabilities and the second set of capabilities comprises a list of capabilities, and the list includes, for each capability on the list, a first value associated with the first set of capabilities and a second value associated with the second set of capabilities. In some of these examples, the list of capabilities includes one of the following indications regarding the first value and the second value for a particular capability: the first value and the second value match, the first value and the second value do not match, and at least one of the first value and the second value does not exist. In further examples, the indications may be reflected by different color coding, in a manner similar to that described above in connection with color coding the hierarchical tree structure. As discussed previously, a non-existent value may indicate the absence of a value for that particular capability or the presence of a null value for that particular capability.

In some examples, the list of capabilities may be a pre-defined list of a particular number of capabilities that are relevant to ensuring/optimizing connectivity. For example, the list may include the top 10 known capabilities that are relevant to a particular wireless network. In other examples, any suitable number of capabilities may be included in the list of capabilities.

In further examples, the capabilities selected for inclusion in the list of capabilities may be based on one or more of the following: whether a particular capability is mandatory for association, or whether a particular capability allows association but degrades performance if mis-matched. For example, the security algorithms of an access point and a client device must match (e.g., are a mandatory match), but an access point and a client device may still associate even if they support different Wi-Fi versions (e.g., an optional match). In other examples, the list of capabilities may be sorted based on one or more of the following: whether a particular capability is mandatory for association, or whether a particular capability allows association but degrades performance if mis-matched.

In some examples in which the comparison of the first set of capabilities and the second set of capabilities comprises a list of capabilities, the comparison may also include, for a particular capability on the list: a description of a problem associated with a difference between the first value and the second value for the particular capability, and a recommended action to improve connectivity between the access point and the client device. In some of these examples, the recommended action may be based on a group of client devices that have similar capabilities.

Although the foregoing description has focused mainly on the scenarios in which wireless signals are received from a single access point and a single client device, the receiver may receive wireless signals from a plurality of access points and a plurality of client devices, in other examples. In these examples, the controller extracts, from the wireless signals received from the plurality of access points and the plurality of client devices, information that indicates the capabilities of each of the plurality of access points and the plurality of client devices, and information is presented to the user, including a list of the plurality of access points and the plurality of client devices.

In some examples, the list of the plurality of access points and the plurality of client devices is presented to the user in a full compatibility matrix and may also include recommendations to improve connectivity/performance. In other examples, all client devices that are of the same type may be grouped together, and information regarding client devices of that type may be presented to the user. In further examples, the user may use an input mechanism associated with the display to select one of the plurality of access points and one of the plurality of client devices to see a comparison of capabilities between the selected access point and the selected client device.

In still further examples, the information presented to the user may include identification of under-utilized capabilities. For example, it may be determined that there are many client devices in the coverage area of the wireless network that can operate on the 6 GHz frequency but that are not currently associated to the available 6 GHz SSIDs of the wireless network. In response to being notified of such an under-utilized capability, the user may reconfigure one or more of the client devices to operate on the 6 GHz frequency.

The foregoing examples have focused on the scenario shown in FIG. 4A, in which a measurement device is used to receive the wireless signals that are the basis for a wireless communication capability analysis. However, the receiver may be located elsewhere in the system, in other examples. For example, FIG. 4B is a block diagram of an example of a system in which an access point is used to receive the wireless signals that are the basis for a wireless communication capability analysis. In the example shown in FIG. 4B, access point 432 has a receiver to receive one or more wireless signals 428 from access point 420, which is associated with a wireless network having coverage area 426. The receiver of access point 432 also receives one or more wireless signals 430 from client device 424, which is located within coverage area 426 of the wireless network. In the example shown in FIG. 4B, access point 432 also has a controller to perform the wireless communication capability analysis, which is described above. In some examples, access point 432 is further communicatively coupled to a display to present information regarding a comparison of the first set of capabilities and the second set of capabilities to a user.

In other examples, the receiver may be located in another client device. For example, FIG. 4C is a block diagram of an example of a system in which a client device is used to receive the wireless signals that are the basis for a wireless communication capability analysis. In the example shown in FIG. 4C, client device 434 has a receiver to receive one or more wireless signals 428 from access point 420, which is associated with a wireless network having coverage area 426. The receiver of client device 434 also receives one or more wireless signals 430 from client device 424, which is located within coverage area 426 of the wireless network. In the example shown in FIG. 4C, client device 434 also has a controller to perform the wireless communication capability analysis, which is described above. Client device 434 further includes (or is communicatively coupled to) a display to present information regarding a comparison of the first set of capabilities and the second set of capabilities to a user.

Although the foregoing examples are described as having a single receiver that receives the wireless signals that are the basis for a wireless communication capability analysis, other examples may include a plurality of receivers that receive the wireless signals that are the basis for a wireless communication capability analysis. In some of these examples, the plurality of receivers may be located within a single device within the system. In other examples, the plurality of receivers may be located within a plurality of devices within the system, and each receiver is communicatively coupled with one or more controllers that utilize the content of the wireless signals to perform the wireless communication capability analysis.

The foregoing discussion focuses on scenarios in which a wireless communication device receives wireless signals from at least two other wireless communication devices and performs a wireless communication capability analysis on the other wireless communication devices that transmitted the wireless signals. However, in further examples, a wireless communication device can receive wireless signals from one or more other wireless communication devices and perform a wireless communication capability analysis that includes the capabilities of the wireless communication device that received the wireless signals.

For example, access point 432, as shown in FIG. 4B, may be the wireless communication device that performs a wireless communication capability analysis that includes its own capabilities in the analysis. In these examples, the wireless communication device (e.g., access point 432) includes a receiver to receive one or more wireless signals 430 from at least one other wireless communication device (e.g., client device 424) within coverage area 426 of the wireless network. In some examples, the wireless communication device (e.g., access point 432) would also include a controller to extract, from the wireless signals 430 received from the other wireless communication device (e.g., client device 424), first information that indicates a first set of capabilities associated with the other wireless communication device.

In further examples, the controller of the wireless communication device (e.g., access point 432) also generates a comparison of the first set of capabilities and a second set of capabilities. In these examples, the second set of capabilities is associated with the wireless communication device (e.g., access point 432). In some examples, the second set of capabilities is stored within a memory of the wireless communication device (e.g., access point 432). In further examples, the wireless communication device (e.g., access point 432) may also be communicatively coupled to a display to present information regarding the comparison of the first set of capabilities and the second set of capabilities to a user.

In other examples, client device 434, as shown in FIG. 4C, may be the wireless communication device that performs the wireless communication capability analysis that includes its own capabilities in the analysis. In these examples, client device 434 would have a receiver, a controller, and a display that would perform the wireless communication capability analysis that includes its own capabilities in the analysis.

The foregoing examples describe obtaining wireless communication capabilities (1) from information extracted from wireless signals transmitted from wireless communication devices, and (2) from information stored in the memory of a wireless communication device. However, in other examples, a wireless communication device performing a wireless communication capability analysis may be communicatively coupled to a database of known capabilities of various types of wireless communication devices. For example, if it is known that a particular generation of a family of smartphones can support particular Wi-Fi versions, the wireless communication device performing the wireless communication capability analysis can access the database to obtain these known capabilities of a particular wireless communication device when its type is detected. In some examples, the database can be used to obtain capability information in conjunction with, or instead of, extracting capability information from received wireless signals.

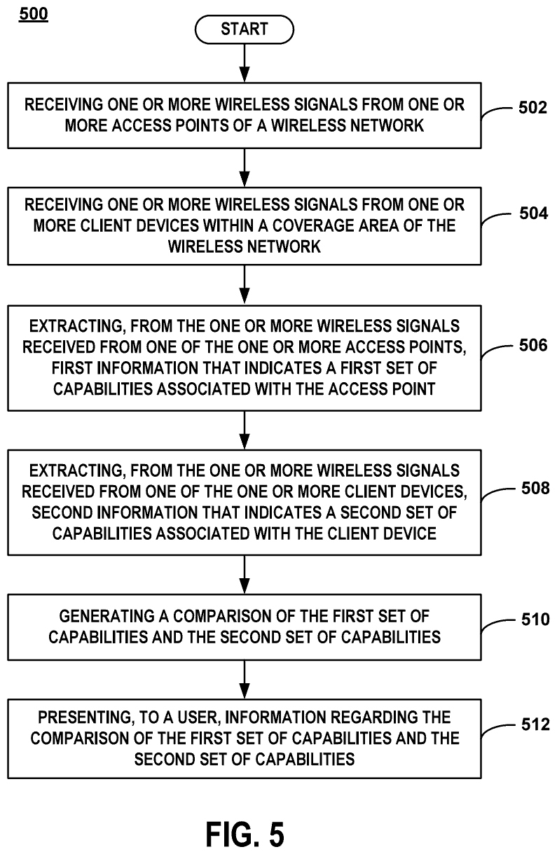

FIG. 5 is a flow chart of a first example of a method for performing a wireless communication capability analysis. The method 500 begins at step 502 with receiving one or more wireless signals from one or more access points of a wireless network. At step 504, the method continues with receiving one or more wireless signals from one or more client devices within a coverage area of the wireless network. In some examples, the wireless signals are received, in steps 502 and 504, by at least one measurement device. In other examples, the wireless signals are received, in steps 502 and 504, by at least one other access point. In further examples, the wireless signals are received, in steps 502 and 504, by at least one other client device.

At step 506, the method further includes extracting, from the one or more wireless signals received from one of the one or more access points, first information that indicates a first set of capabilities associated with the access point. At step 508, the method also includes extracting, from the one or more wireless signals received from one of the one or more client devices, second information that indicates a second set of capabilities associated with the client device. At step 510, the method additionally includes generating a comparison of the first set of capabilities and the second set of capabilities. In some examples, the controller of the measurement device extracts the information and generates the comparison, as described in connection with steps 506, 508, and 510. In other examples, a controller of a local computing device to which the measurement device is connected may extract the information and generate the comparison, as set forth in steps 506, 508, and 510. At step 512, information regarding the comparison of the first set of capabilities and the second set of capabilities is presented to a user.

In other examples, one or more of the steps of method 500 may be omitted, combined, performed in parallel, or performed in a different order than that described herein or shown in FIG. 5. In still further examples, additional steps may be added to method 500 that are not explicitly described in connection with the example shown in FIG. 5. For example, in other examples, method 500 may additionally include transmitting, to the client device, one or more disassociation frames to cause the client device to re-associate with the access point.

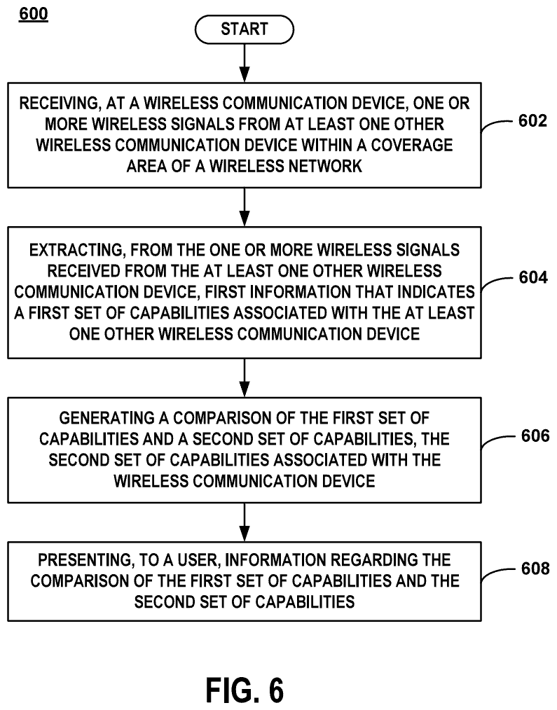

FIG. 6 is a flow chart of a second example of a method for performing a wireless communication capability analysis. The method 600 begins at step 602 with receiving, at a wireless communication device, one or more wireless signals from at least one other wireless communication device within a coverage area of a wireless network. At step 604, the method continues with extracting, from the one or more wireless signals received from the at least one other wireless communication device, first information that indicates a first set of capabilities associated with the at least one other wireless communication device. At step 606, the method further includes generating a comparison of the first set of capabilities and a second set of capabilities, which are associated with the wireless communication device. In some examples, the controller of the measurement device extracts the information and generates the comparison, as described in connection with steps 604 and 606. In other examples, a controller of a local computing device to which the measurement device is connected may extract the information and generate the comparison, as set forth in steps 604 and 606. At step 608, information regarding the comparison of the first set of capabilities and the second set of capabilities is presented to a user.

In other examples, one or more of the steps of method 600 may be omitted, combined, performed in parallel, or performed in a different order than that described herein or shown in FIG. 6. In still further examples, additional steps may be added to method 600 that are not explicitly described in connection with the example shown in FIG. 6.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A system for performing wireless communication capability analysis, the system comprising:
a receiver to:
receive one or more wireless signals from one or more access points of a wireless network, and
receive one or more wireless signals from one or more client devices within a coverage area of the wireless network;
a controller to:
extract, from the one or more wireless signals received from one of the one or more access points, first information that indicates a first set of capabilities associated with the access point,
extract, from the one or more wireless signals received from one of the one or more client devices, second information that indicates a second set of capabilities associated with the client device, and
generate a comparison of the first set of capabilities and the second set of capabilities; and
a display to present, to a user, information regarding the comparison of the first set of capabilities and the second set of capabilities.

2. The system of claim 1, wherein the receiver is located in a measurement device.

3. The system of claim 1, wherein the receiver is located in another access point.

4. The system of claim 1, wherein the receiver is located in another client device.

5. The system of claim 1, wherein the receiver receives the one or more wireless signals from the client device during an association frame exchange.

6. The system of claim 1, wherein the receiver receives the one or more wireless signals during a scanning procedure.

7. The system of claim 1, wherein the comparison comprises a hierarchical tree structure indicating one or more differences between the first set of capabilities and the second set of capabilities.

8. The system of claim 1, wherein the comparison comprises a list of capabilities, the list including, for each capability on the list, a first value associated with the first set of capabilities and a second value associated with the second set of capabilities.

9. The system of claim 8, wherein the list of capabilities includes one of the following indications regarding the first value and the second value for a particular capability: the first value and the second value match, the first value and the second value do not match, and at least one of the first value and the second value does not exist.

10. The system of claim 8, wherein the comparison further comprises, for a particular capability on the list:
a description of a problem associated with a difference between the first value and the second value for the particular capability, and
a recommended action to improve connectivity between the access point and the client device.

11. The system of claim 10, wherein the recommended action is based on a group of client devices that have similar capabilities.

12. The system of claim 1, wherein the receiver further receives wireless signals from a plurality of access points and a plurality of client devices, the controller further extracts, from the wireless signals received from the plurality of access points and the plurality of client devices, information that indicates the capabilities of each of the plurality of access points and the plurality of client devices, the information presented to the user including a list of the plurality of access points and the plurality of client devices.

13. The system of claim 12, further comprises:
an input mechanism by which the user selects one of the plurality of access points and one of the plurality of client devices to see a comparison of capabilities between the selected access point and the selected client device.

14. The system of claim 1, further comprising:
a transmitter to transmit, to the client device, one or more disassociation frames to cause the client device to re-associate with the access point.

15. A wireless communication device for performing wireless communication capability analysis in a wireless network, the wireless communication device comprising:
a receiver to receive one or more wireless signals from at least one other wireless communication device within a coverage area of the wireless network;
a controller to:
extract, from the one or more wireless signals received from the at least one other wireless communication device, first information that indicates a first set of capabilities associated with the at least one other wireless communication device, and
generate a comparison of the first set of capabilities and a second set of capabilities, the second set of capabilities associated with the wireless communication device; and
a display to present, to a user, information regarding the comparison of the first set of capabilities and the second set of capabilities.

16. The wireless communication device of claim 15, wherein the wireless communication device is an access point.

17. The wireless communication device of claim 15, wherein the wireless communication device is a client device.

18. The wireless communication device of claim 15, wherein the at least one other wireless communication device is a client device and the receiver receives the one or more wireless signals from the client device during an association frame exchange.

19. The wireless communication device of claim 15, wherein the receiver receives the one or more wireless signals during a scanning procedure.

20. The wireless communication device of claim 15, wherein the comparison comprises a hierarchical tree structure indicating one or more differences between the first set of capabilities and the second set of capabilities.

21. The wireless communication device of claim 15, wherein the comparison comprises a list of capabilities, the list including, for each capability on the list, a first value associated with the first set of capabilities and a second value associated with the second set of capabilities.

22. The wireless communication device of claim 21, wherein the list of capabilities includes one of the following indications regarding the first value and the second value for a particular capability: the first value and the second value match, the first value and the second value do not match, and at least one of the first value and the second value does not exist.

23. The wireless communication device of claim 21, wherein the comparison further comprises, for a particular capability on the list:
a description of a problem associated with a difference between the first value and the second value for the particular capability, and
a recommended action to improve connectivity between the access point and the client device.
